(19) United States
(12) Patent Application Publication
(10) Pub. No.: US 2012/0120642 A1
(43) Pub. Date: May 17, 2012

(54) Inflatable Solar Light

(76) Inventors: Andrea Mary Sreshta, Houston, TX (US); Anna Ruth Stork, Sherborn, MA (US)

(21) Appl. No.: 13/163,239

(22) Filed: Jun. 17, 2011

Related U.S. Application Data
(60) Provisional application No. 61/356,274, filed on Jun. 18, 2010.

(51) Int. Cl. F21L 4/08

(52) U.S. Cl. 362/183

(57) ABSTRACT

A solar rechargeable light is disclosed. In some embodiments, the solar light include the following: an expandable inner bladder including at least front and bottom surfaces; a solar rechargeable light assembly joined with the front surface of the inner bladder, the assembly including a thin-film photovoltaic, a battery charger in electrical communication with the thin-film photovoltaic, a rechargeable battery in electrical communication with the battery charger, and a light emitting diode in electrical communication with the rechargeable battery; and an expandable outer bladder configured to contain the inner bladder. The inner and outer bladders are substantially transparent, flexible, inflatable, and collapsible.

### CROSS REFERENCE TO RELATED APPLICATION(S)

This application claims the benefit of U.S. Provisional Application No. 61/356,274, filed Jun. 18, 2010, which is incorporated by reference as if disclosed herein in its entirety.

### BACKGROUND

Sustainable lighting solutions are essential to relief efforts in areas affected by natural disasters, war, and other events that leave large areas without electricity. Rechargeable batteries coupled to photovoltaic cells are an ideal sustainable approach to providing light when the sun goes down. Current solar-charged light solutions are expensive and difficult to transport which make them costly to deploy in large numbers.

Battery- or fuel-powered lighting solutions have the obvious disadvantage of recurring cost and limited resources. On the other hand, most renewable lighting solutions require expensive components and are large and difficult to ship.

### SUMMARY

Some embodiments of the disclosed subject matter include a solar rechargeable light that is expandable for use and collapsible for packing. In some embodiments, the solar light includes the following: an expandable inner bladder including at least front and bottom surfaces; a solar rechargeable light assembly joined with the front surface of the inner bladder, the assembly including a photovoltaic panel, a battery charger in electrical communication with the photovoltaic panel, a rechargeable battery in electrical communication with the battery charger, and a light emitting diode in electrical communication with the rechargeable battery; and an expandable outer bladder configured to contain the inner bladder. The inner and outer bladders are substantially transparent, flexible, inflatable, and collapsible.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a front isometric exploded view of a solar light according to some embodiments of the disclosed subject matter;

FIG. 2 is a front view of a solar light according to some embodiments of the disclosed subject matter;

FIG. 3 is a side view of a solar light according to some embodiments of the disclosed subject matter;

FIG. 4 is a front view of an outer bladder of a solar light according to some embodiments of the disclosed subject matter;

FIG. 5 is a back view of an outer bladder of a solar light according to some embodiments of the disclosed subject matter;

FIG. 6 is a front view of an inner bladder of a solar light according to some embodiments of the disclosed subject matter;

FIG. 7 is a back view of an inner bladder of a solar light according to some embodiments of the disclosed subject matter;

FIG. 8 is a front isometric view of an inner bladder of a solar light according to some embodiments of the disclosed subject matter;

FIG. 9 is a front isometric view of a light assembly of a solar light according to some embodiments of the disclosed subject matter;

FIG. 10 is a front view of a light assembly of a solar light according to some embodiments of the disclosed subject matter;

FIG. 11 a side view of a light assembly of a solar light according to some embodiments of the disclosed subject matter;

FIG. 12 a side view of a solar light according to some embodiments of the disclosed subject matter in a first, collapsed state; and

FIG. 13 a side view of a solar light according to some embodiments of the disclosed subject matter in a second, expanded state.

### DETAILED DESCRIPTION

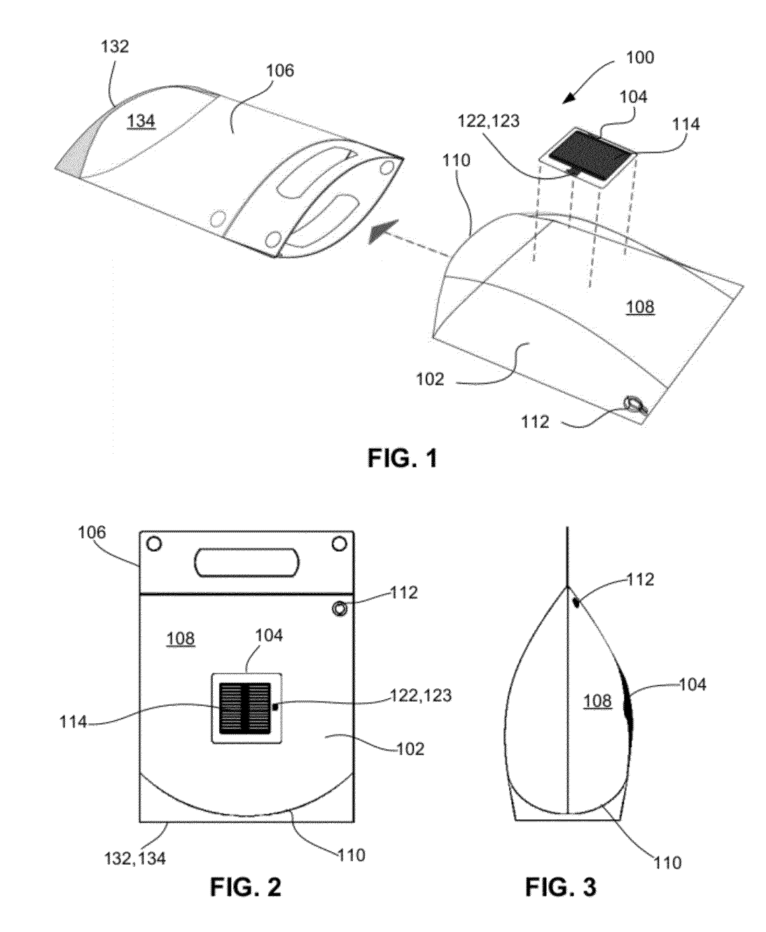

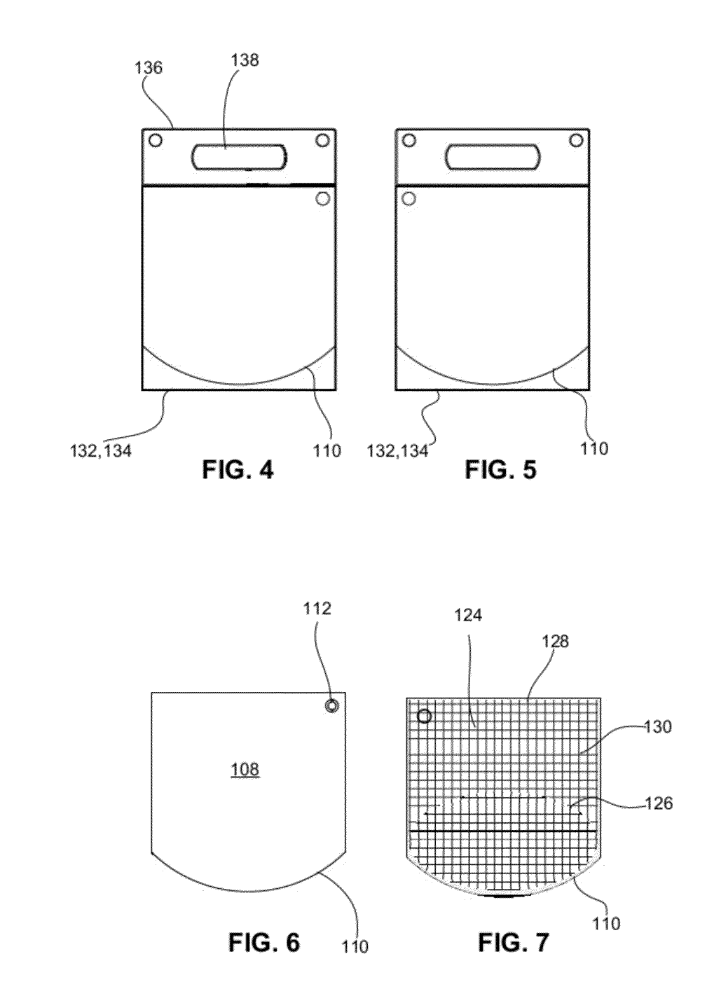

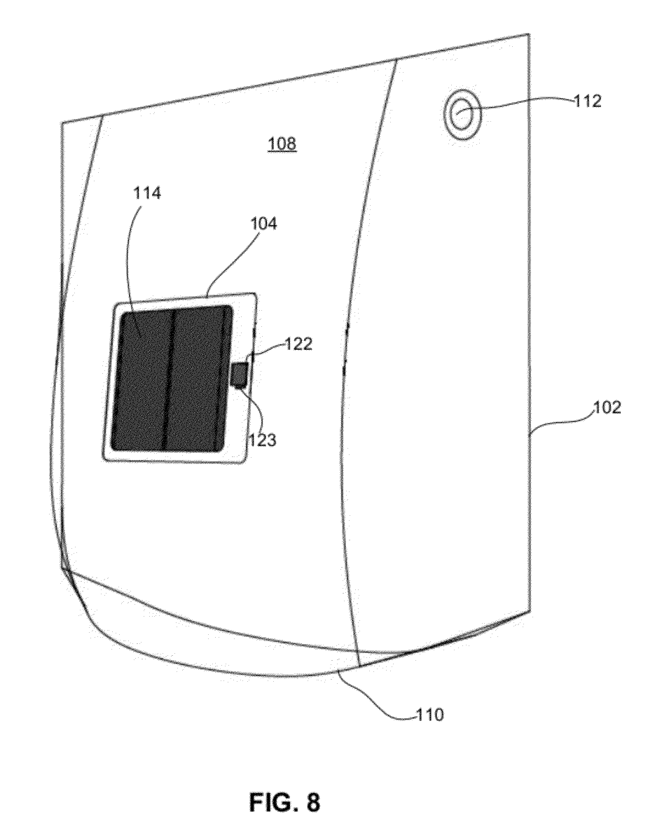

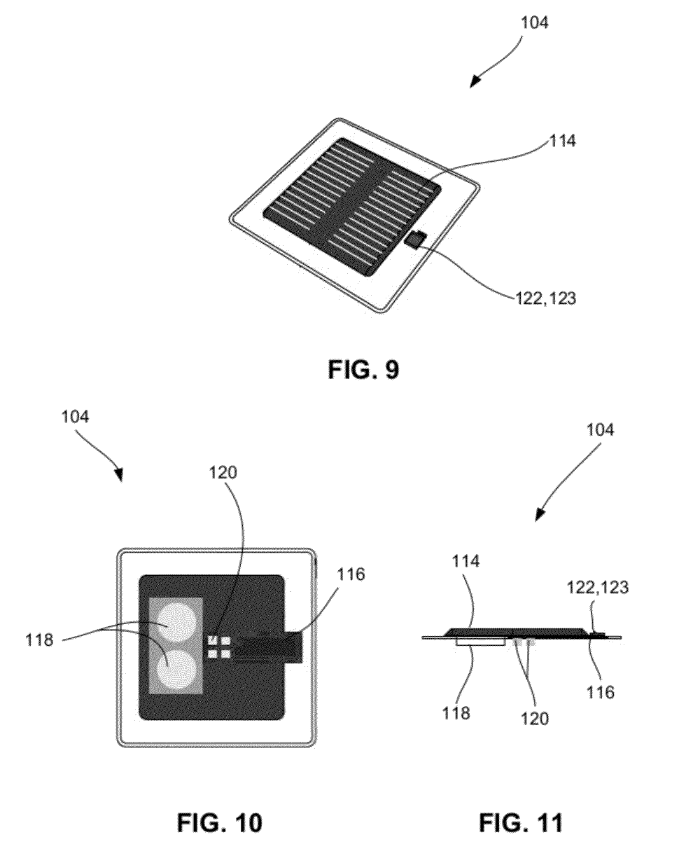

Referring now to FIGS. 1-13, aspects of the disclosed subject matter include a solar rechargeable light 100 including an inner bladder 102, a solar rechargeable light assembly 104, and an outer bladder 106. Light 100 is expandable by filling inner bladder 102 with a gas, liquid, or solid.

In some embodiments, inner bladder 102 has at least a front surfaces 108 and 110, respectively. In some embodiments, inner bladder 102 includes a valve 112 through which the inner bladder can be expanded and collapsed by inflating filling and deflating or emptying, respectively. Inner bladder 102 is typically filled with one or more of a gas, e.g., air, liquid, and solid.

As best shown in FIGS. 1-3 and 9-11, solar rechargeable light assembly 104 is joined with front surface 108 of said inner bladder 102. Solar rechargeable light assembly 104 includes a photovoltaic panel 114, a battery charger 116 in electrical communication with the photovoltaic panel, one or more rechargeable batteries 118 in electrical communication with the battery charger, and one or more light emitting diodes (LED) 120 in electrical communication with the rechargeable batteries. Battery charger 116 typically includes an integrated circuit chip with overcharge control. In some embodiments, rechargeable batteries 118 include two 3.7 volt coin cell batteries. Of course, other size batteries are contemplated depending on the particular application.

In some embodiments, assembly 104 includes more than one LED 120, e.g., four LEDs, in electrical communication with rechargeable batteries 118. Embodiments including more than one LED 120 typically have an increased viewing angle, e.g., four LEDs provides about a 100 to 120 degree viewing angle, which provide approximately 30-40 lumens of light. In some embodiments assembly 104 includes a power switch 122 in electrical communication with rechargeable batteries 118 and LEDs 120. Switch 122 is configured to selectively introduce and prevent the flow of electricity from batteries 118 to LEDs 120. Switch 122 is configured so that a user can control the amount of light output by light 100, e.g., includes off, low, high settings. This can be achieved in at least two ways. First, where there is more than one LED 120, switch 122 can be configured so as to selectively introduce and prevent the flow of electricity from batteries 118 to a desired number of LEDs 120. Alternatively, regardless of the number of LEDs 120, switch 122 can be configured to selectively regulate the flow of electricity from the batteries to the LEDs. In some embodiments, switch 122 is configured to prevent accidental turn-on, e.g., has enough resistance to being switched and is concave. Some embodiments include charging lights 123 for indicating whether batteries 118 are charged, e.g., a red LED for indicating that the batteries are not charged and a green LED for indicating that the batteries are fully charged. Charging lights 123 are in communication with battery charger 116. In some embodiments, depending on the size of thin-film photovoltaic 114, strength of batteries 118, and number of LEDs 120, the batteries will provide enough power to energize the LEDs for 8 hours on a low setting and 4-6 hours on a high setting, and the batteries will recharge after 5-8 hours in the sun.

Referring now to FIGS. 1-7, outer bladder 106, which is also expandable, is configured to contain inner bladder 102. One or more of inner bladder 102 and outer bladder 106 is typically fabricated from a frosted plastic material or similar to promote diffusion of light from LEDs 120. One or more of inner bladder 102 and outer bladder 106 typically includes one or more surfaces 124 having a particular pattern 126 configured to promote diffusion of light from LEDs 120. In some embodiments, pattern 126 includes a white background portion 128 having a grid of transparent portions 130 thereby defining an about thirty percent transparent white pattern. Outer bladder 106 is typically sealable so that light 100 both floats and is substantially waterproof. In some embodiments, outer bladder 106 includes a bottom portion 132 that has a flat bottom surface 134 and a top portion 136 defining a handle 138. As assembled, bottom surface 110 of inner bladder 102 rests on or is adjacent to bottom surface 134. Flat bottom surface 134 generally allows light 100 to be positioned so as to stand in an upright position. Both outer bladder 106 and inner bladder 102 are generally fabricated from materials that are substantially transparent, flexible, inflatable, and collapsible.

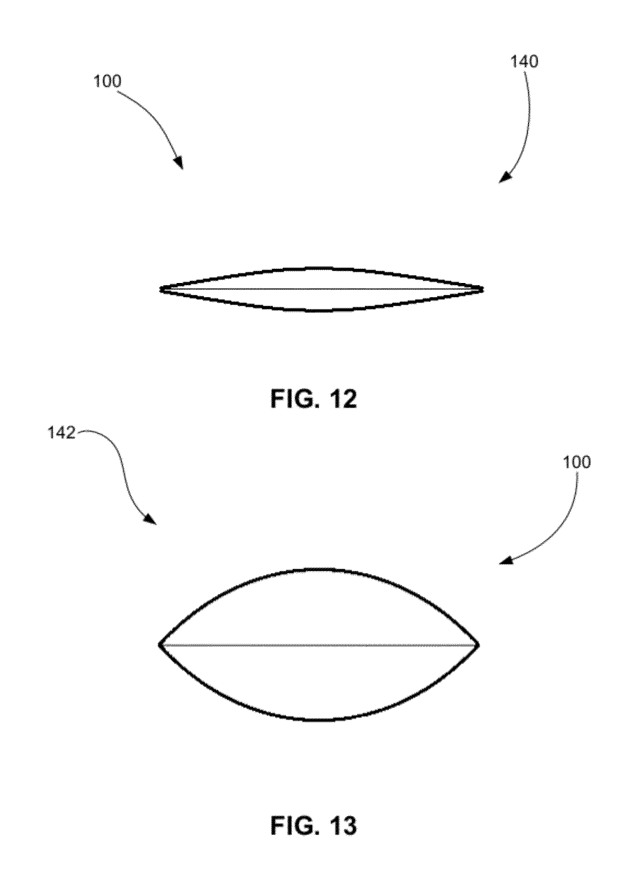

Referring now to FIGS. 12 and 13, in use, light 100 is configured so as to have first and second states 140 and 142, respectively. In first state 140, inner bladder 102 is substantially free of gas, liquids, and solids and light 100 is substantially collapsed. In second state 142, inner bladder 102 includes one or more of a gas, liquid, and solid and light 100 is substantially expanded.

Lights according to the disclosed subject matter offer benefits over known technology. In the wake of a natural disaster, because they are collapsible, they can be shipped in conjunction with other disaster relief supplies. Families and individuals in tent cities are in desperate need of light to improve safety at night. Children need light at night to continue their studies. Lights according to the disclosed subject matter are a cost effective improvement over flashlights and kerosene lanterns. Lights according to the disclosed subject matter are also designed to provide light to individuals with little to no access to a functioning electrical grid. In developing nations, the World Bank estimates that families spend an average of 30% of their disposable income on kerosene lamps and other forms of non-renewable lighting. Lights according to the disclosed subject matter are designed to last 3-5 years. The money families are able to save will allow them to buy food and other necessities.

Lights according to the disclosed subject matter can be used by campers and hikers in outdoor uses as a rechargeable, easy transportable light source. They are waterproof and can be used in water sport activities. They can also be used as a household pool light.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A solar rechargeable light, comprising:
an expandable inner bladder including a front surface;
a solar rechargeable light assembly joined with said front surface of said inner bladder; and
an expandable outer bladder configured to contain said inner bladder.

2. The light of claim 1, said assembly further comprising:
a photovoltaic panel;
a battery charger in electrical communication with said photovoltaic panel;
a rechargeable battery in electrical communication with said battery charger; and
a light emitting diode in electrical communication with said rechargeable battery.

3. The light of claim 1, wherein said inner bladder further comprises a valve through which said inner bladder is inflated or filled and deflated or emptied.

4. The light of claim 3, wherein said inner bladder is filled with one or more of a gas, liquid, and solid.

5. The light of claim 1, wherein one or more of said inner and outer bladders is fabricated from a frosted plastic material to promote diffusion of light from said light emitting diode.

6. The light of claim 1, wherein one or more of said inner and outer bladders includes one or more surfaces having a particular pattern configured to promote diffusion of light from said light emitting diode.

7. The light of claim 6, wherein said pattern includes a white background portion having a grid of transparent portions thereby defining an about thirty percent transparent white pattern.

8. The light of claim 1, wherein said outer bladder is sealable so that said light both floats and is substantially waterproof.

9. The light of claim 2, further comprising a power switch in electrical communication with said rechargeable battery and said light emitting diode, wherein said switch can be selectively controlled to both introduce and prevent the flow of electricity from said battery to said light emitting diode.

10. The light of claim 1, wherein in a first state, said inner bladder is substantially free of gas, liquids, and solids and said light is substantially collapsed and wherein in a second state, said inner bladder includes one or more of a gas, liquid, and solid and said light is substantially expanded.

11. The light of claim 2, wherein said assembly includes more than one light emitting diode in electrical communication with said rechargeable battery.

12. The light of claim 11, further comprising a power switch in electrical communication with said rechargeable battery and said light emitting diodes, wherein said switch can be configured to control an amount of light provided by said light.

13. A solar rechargeable light, comprising:
an expandable inner bladder including a front surface;
a solar rechargeable light assembly joined with said front surface of said inner bladder, said assembly including a thin-film photovoltaic, a battery charger in electrical communication with said thin-film photovoltaic, a rechargeable battery in electrical communication with said battery charger, and a light emitting diode in electrical communication with said rechargeable battery; and
an expandable outer bladder configured to contain said inner bladder;
wherein said inner and outer bladders are substantially transparent, flexible, inflatable, and collapsible.

14. The light of claim 13, wherein said inner bladder further comprises a valve through which said inner bladder is inflated or filled and deflated or emptied.

15. The light of claim 14, wherein said inner bladder is filled with one or more of a gas, liquid, and solid.

16. The light of claim 13, wherein said outer bladder includes one or more surfaces having a particular pattern configured to promote diffusion of light from said light emitting diode.

17. The light of claim 13, wherein in a first state, said inner bladder is substantially free of gas, liquids, and solids and said light is substantially collapsed and wherein in a second state, said inner bladder includes one or more of a gas, liquid, and solid and said light is substantially expanded.

18. The light of claim 13, wherein said assembly includes more than one light emitting diode in electrical communication with said rechargeable battery.

19. The light of claim 13, further comprising a power switch in electrical communication with said rechargeable battery and said light emitting diodes, wherein said switch can be configured to control an amount of light provided by said light.

20. The light of claim 13, wherein said outer bladder includes a bottom portion that has a flat bottom surface and a top portion defining a handle.
